(19) United States
(12) Patent Application Publication
(10) Pub. No.: US 2005/0028209 A1
(43) Pub. Date: Feb. 3, 2005

(54) Method in a digital mobile station, a digital mobile station, application software, and a system for displaying visual information

(75) Inventor: Ari Sinisalo, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/659,048

(22) Filed: Sep. 9, 2003

(30) Foreign Application Priority Data
Sep. 10, 2002 (FI) FI 20021619

(51) Int. Cl. H04N 7/16; H04N 7/18

(52) U.S. Cl. 725/62; 725/80; 725/81

(57) ABSTRACT

The invention relates to a method in a digital mobile station (MS), which mobile station (MS) for a wireless transmission connection comprises at least one or more digital signal processors (DSP) or corresponding processing means for generating a digital transmission signal flow (DTR). According to the invention, said one or more digital signal processors (DSP) or corresponding processing means are controlled to generate, instead of a digital transmission signal flow (DTR), one or more digital video signal flows (DV, DCV) from image material stored in or transmitted into the memory (MEM) of the mobile station (MS), which one or more digital video signal flows are further led to a digital or analog video output (Vout) of the mobile station (MS). The video output (Vout) can be generated, for example, as an analog composite video signal or a digital video signal according to the IEEE 1394 standard. The invention also relates to a digital mobile station (MS) implementing the method, application software for a mobile station, as well as a system for displaying visual information.

### CROSS REFERENCE TO RELATED APPLICATION

This application claims priority under 35. USC 119 to Finnish Application No. 20021619 filed Sep. 10, 2002.

### BACKGROUND OF THE INVENTION

The invention relates to a method enabling to connect a digital mobile station to an external audiovisual display device. The invention also relates to a digital mobile station implementing said method. Furthermore, the invention relates to application software for a digital mobile station and implementing said method. The invention also relates to a system for displaying visual information.

Wireless digital communication networks and their use are rapidly expanding. Technological development in digital wireless communication also makes it possible to continuously create new uses in addition to communication based on conventional speech transmission. With modern digital mobile stations (MS) it is already possible to transmit not only speech and text-based short messages (Short Message Service, SMS) but also data and various multimedia messages (Multimedia Messaging Service, MMS). The multimedia messages may contain for example video and audio clips. The trend is further to introduce even more sophisticated functions, similar to e.g. Internet services, in digital mobile stations and other corresponding wireless and portable terminals.

As the uses of mobile stations become more versatile, this will naturally also involve the development of their data processing capacity and facilities (storage capacity, processor output, software attributes). Even at present, the most sophisticated commercially available mobile stations, exemplified by the Nokia Communicator™, comprise not only conventional mobile station functions but also data processing functions, such as text processing and spreadsheet facilities. The newest versions of the Nokia Communicator™ device are capable of displaying for example Microsoft PowerPoint™ slide presentations in colours on the device's own display. However, on the device's own display, the presentation can be satisfactorily viewed by not more than a few persons in addition to the user of the device. Therefore, it can be foreseen that in a relatively large number of applications in the future, the limiting factor will not be the data processing properties but the display of the mobile station and the related properties.

Consequently, it can be expected that increasing interest will be drawn in utilizing easily portable mobile stations as instruments in various audiovisual presentations aimed at larger groups of people, along with the improvement in the data processing properties of mobile stations. Situations, in which mobile stations could be used as display devices, include for example various product demonstrations, meetings and seminars. Commercially significant applications to be envisaged also include various entertaining functions included in mobile stations, for example games whose watching on a larger display would make their use more pleasant and interesting.

Until now, however, it has not been possible to connect a mobile station readily and directly without special auxiliary devices to e.g. a video gun, a television set, or another separate display device to display audiovisual material produced or stored in the mobile station.

A commercially available auxiliary device is known from prior art to facilitate the use of a mobile station as a display device. This so-called Irma™ device uses a wireless infrared link to transmit digital images (Microsoft Powerpoint™ slides) from the memory of a mobile station (Nokia Communicator™) to its own memory, converts these images further to analog VGA (Video Graphics Array) video signals and transmits the VGA video signals further by means of a VGA cable to a separate data projector. In a known manner, a VGA cable is used to transmit R, G and B signals (RGB, Red Green Blue) of an image as separate analog signals, and also the horizontal and vertical synchronization signals of the image. However, this solution is limited for use in connection with a mobile station of a given type and a given application only. Furthermore, it is an obvious drawback of the solution that for connecting the mobile station to the data projector, the use and transportation of the separate Irma™ device will always be required. The assortment of display devices suitable for the purpose is also relatively limited, because VGA connections are primarily used in various data projectors and computer displays only. Furthermore, in practice, the lengths of connection cables for VGA video signals are typically limited to a maximum of only a few metres.

### SUMMARY OF THE INVENTION

It is an aim of the present invention to disclose a completely novel type of solution which makes it possible to connect a digital mobile station to an external audiovisual display device (briefly AV device hereinbelow) or, more generally, to any general-purpose device equipped with an analog or digital video connection, in a significantly less complex manner than in prior art.

The invention thus makes it possible to use the mobile station, for example, as a display device in demonstrations to a large public. On the other hand, the invention also makes it possible to connect, for example, a television set or another large monitor as a display for the mobile station. A larger display device is advantageous, for example, when playing games included in the mobile station or when using the mobile station as an Internet terminal.

The solution according to the invention does not require the use of any separate adapter device between the mobile station and the AV device, for example a video gun or a video screen, but by means of the invention, the mobile station can be connected to the AV device available at the time by means of a simple and conventional video cable.

In a first embodiment of the invention, a transmission mode based on an analog composite video signal is used, having the significant advantage that there is a very large variety of devices equipped with an appropriate analog video connection, ranging from inexpensive home television sets up to various computer devices intended for image processing.

In a second embodiment of the invention, a transmission mode based on a digital video signal is used, for example according to the IEEE 1394 standard. This embodiment has the advantage of good image quality. It is true that the availability of AV devices equipped with a digital video connection, such as e.g. a FireWire™ or i.Link™ connection, is still relatively limited, but the supply of these devices will increase at an increased rate in the future. This trend is also speeded up by the development of digital television technology.

To attain these purposes, the solution according to the invention is primarily characterized in that for generating a video signal for an external audiovisual display device in a mobile station, at least one or more existing digital signal processors or corresponding processing means of the mobile station are controlled to generate, instead of the data communication transmission signal flow, one or more digital video signal flows from image material stored in or transmitted into the memory of the mobile station.

It is well known as such that the wireless connection of modern digital mobile stations on the radio channel is based, to a relatively essential degree, on the utilization of an efficient digital signal processor (DSP). One or more digital signal processors are used in the mobile station to process a wideband signal flow in digital form, which signal flow, or bit stream, is led after a digital-to-analog (D/A) conversion to an analog radio frequency part. The radio frequency part will transmit this analog signal further onto the radio channel. The digital signal processor of the mobile station is also used for the processing of a received signal, when an analog signal received from the radio channel by means of the radio frequency part has first been demodulated and converted by means of an analog-to-digital (A/D) converter to a suitable digital format.

The basic idea of the present invention is to utilize one or more digital signal processors, which are readily provided for a wireless transmission connection in modern digital mobile stations, in a completely novel way to produce one or more digital or analog video signals already in the mobile station.

In a first embodiment of the invention, one or more digital signal processors included in the mobile station are arranged to produce, from image material in the memory of the mobile station, a composite video signal in digital format. This digital composite video signal is led further to the D/A converter of the mobile station to convert the signal to the actual analog composite video signal according to the desired standard and to be possibly led further to an AV device by means of only one signal conductor. Analog composite video signal standards, which are well known as such, include for example PAL (Phase Alteration Line), NTSC (National Television Standards Committee) and SECAM (Système Électronique Pour Couleur Avec Mèmoire). Said standards differ from each other, for example, in the number of lines in the image and the colour specifications, in ways known as such. However, the invention should not be considered to be limited solely to the above mentioned analog video signal standards, but also other analog video signals using one or more signal conductors, known as such, are feasible.

According to the invention, an analog video signal formed in a mobile station is led via a suitable interface from the mobile station to the actual AV device, such as e.g. a television set, a video screen or a video projector, or another device receiving an analog video signal.

In another embodiment of the invention, one or more digital signal processors included in the mobile station are arranged to produce, from image material in the memory of the mobile station, a video signal in digital format, for example a signal complying with the IEEE 1394 standard. This digital video signal is led via a suitable interface from the mobile station to the actual AV device by using one or more digital signal lines. The invention is not limited solely to digital video signals according to the IEEE 1394 standard, but by means of the invention, it is also possible to produce e.g. video signals which are suitable for a digital television environment. These standards vary in different countries and are still partly under development.

Consequently, the most significant advantage to be achieved with the invention is that the user may couple his/her mobile station to a desired AV device by means of a simple analog or digital video cable without other separate auxiliary devices. The user only needs to carry along the mobile station and possibly a suitable video cable, or a small-size adapter which makes it possible to use a video cable of a conventional standard.

The invention is not limited solely to the displaying of still images, but if the mobile station is equipped with a sufficiently quick memory, a digital signal processor and other resources that are possibly needed, the invention can also be used to produce an analog or digital video signal of a moving image, such as video clips.

Furthermore, in the case of analog video signals, the invention is not limited solely to the production of an analog composite video signal. If one or more digital signal processors of the mobile station, originally needed for the wireless data transmission connection, have the sufficient capacity, they may also be used, for example, to generate so-called S-video signals of analog format. In this case, separate video signals are generated for the luminance and chrominance information of the image. Also other analog video signals known as such, and those utilizing more than one signal conductor, as well as digital video signals with one or more conductors, are feasible.

By means of the invention, the display device used for the mobile station may be, for example, a video gun, a video screen, or a television set. Furthermore, the mobile station can also be coupled directly to various recording devices, such as video recorders, video cameras, DVD devices (Digital Versatile Disc), or computer devices equipped with a video connection.

The invention makes the use of the mobile station as a display device more versatile for example at meetings and seminars. For the use of games or other entertainment functions of the mobile station, the mobile station can be connected, for example, to a television set. Thanks to the invention, a mobile station equipped with a camera, a so-called camera phone, can be connected to a video screen or a television set to show pictures taken with the camera. The camera phone can also be connected to various recording devices to store the images. If video clips or even movies have been stored in the memory of an efficient mobile station, these can be watched by means of a video screen, a video gun or a television set.

The solution according to the invention can be implemented in modern mobile stations by relatively small modifications which are primarily related to the software of the mobile station. The modifications required in the mobile station on the hardware level are small and can thus be easily implemented.

A restriction of the invention is that when the digital signal processor(s) and possibly also the D/A converter of the mobile station are generating a video signal for an external AV device, the mobile station cannot simultaneously communicate with a communication network on the radio channel. Consequently, the mobile station cannot be simultaneously used, for example, for speech or data transmission.

### SHORT DESCRIPTION OF THE DRAWINGS

In the following, the invention will be described in more detail with reference to the appended drawings, in which

FIG. 1 shows, in a block diagram in principle, the most important functional blocks of a mobile station generating an analog composite video signal, and its connection to an external AV device, and

FIG. 2 shows, in a block diagram in principle, the most important functional blocks of a mobile station generating a digital video signal, and its connection to an external AV device.

### DETAILED DESCRIPTION OF THE INVENTION

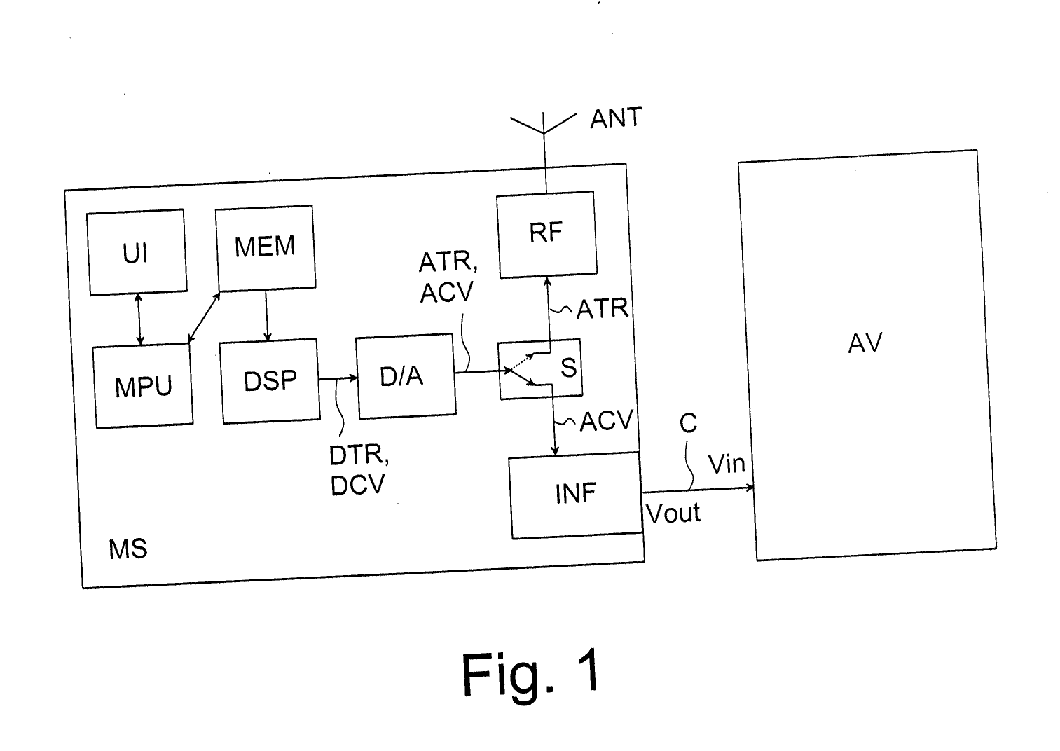

The mobile station MS of FIG. 1 comprises a processor MPU and elements which are functionally connected with the processor: a memory MEM, a user interface UI, a digital signal processor DSP, a digital-to-analog converter D/A (briefly a converter D/A hereinbelow), and a radio part RF. The processor MPU may be, for example, a microprocessor or a microcontroller. The memory MEM preferably comprises both a non-volatile memory (ROM, Read Only Memory) and a random access memory (RAM). The user interface UI preferably provides the user with a display and a keyboard for using the mobile station MS.

When the mobile station MS is normally used as, for example, a mobile phone, the digital signal processor DSP, controlled by the processor MPU, produces a wideband bit stream DTR specific to the respective digital communication network (for example GSM, Global System for Mobile Communications, or WCDMA, Wideband Code Division Multiple Access). The bit stream DTR is further converted in the converter D/A to an analog signal ATR and transmitted by the radio part RF via an antenna ANT further onto the radio channel.

According to the invention, instead of the output of the converter D/A being coupled to the radio part RF (broken line in block S), the output of the converter D/A is coupled by a switching means S (solid line in block S), controlled by the processor MCU, via an adapter INF to an analog video output Vout of the mobile station MS. The adapter INF preferably comprises a buffer amplifier and means for adapting the impedance of the video output Vout to the respective video standard. Further, the adapter INF also comprises a suitable fitting to couple a video cable C to the mobile station MS. The other end of the video cable C is connected to the analog video input Vin of the AV device. The adapter INF may also comprise protection couplings, implemented by methods known as such, for protecting the electronics of the mobile station MS from electrical interference or excess voltages coming in via the analog video output Vout.

In a way characteristic to the invention and in accordance with a first embodiment of the invention, the digital signal processor DSP of FIG. 1 is, controlled by the processor MPU, arranged to produce from image material stored in the memory MEM a composite video signal DCV in digital format, the digital composite video signal DCV being further led to the converter D/A to convert the signal to the actual analog composite video signal ACV. Composite video signals according to a standard include, for example, signals complying with the PAL, NTSC, SECAM systems, which combine, in a way known as such, information on the luminance and chrominance of the image, as well as on the horizontal and vertical synchronization of the image, according to image lines, in a single analog signal. A significant advantage of the analog composite video signal ACV is that it can be transmitted even long distances by means of a simple single-core coaxial cable or the like, without interference.

Described in more detail, the operation of the mobile station according to the invention may be, for example, the following. The image data relating to a still or moving image to be displayed on the display of the mobile station is stored in a memory MEM. The memory allocated for the purpose may preferably be, for example, a memory of the SDRAM type (Synchronous Dynamic Random Access Memory), or the like. From the memory MEM, the image data is transmitted, one image at a time, to the memory of the digital signal processor DSP, by using a fast data transmission channel, such as a DMA channel (Direct Memory Access). The transmission of a single image is preferably performed by transferring the single horizontal lines of the image from the memory MEM to the digital signal processor DSP temporally in succession, always one image line at a time. Now, the digital signal processor DSP produces from these single image lines a digital composite video signal DCV which is converted in the converter D/A to an analog composite video signal ACV.

On the basis of the image lines received, the digital signal processor DSP must also generate the horizontal and vertical synchronization signals of a single image, which two signals it further combines with luminance and chrominance signals generated by it, to produce the complete analog composite video signal ACV.

Preferably, the digital video signal DCV output from the digital signal processor DSP is converted to analog format by the digital-to-analog converter D/A, but in principle, the conversion can also be made, for example, by low-pass filtering. If the digital bit stream produced by the digital signal processor DSP is arranged to be, for example, pulse width modulated, such a bit stream can be low-pass filtered in a way known as such to produce the analog signal without an actual digital-to-analog conversion.

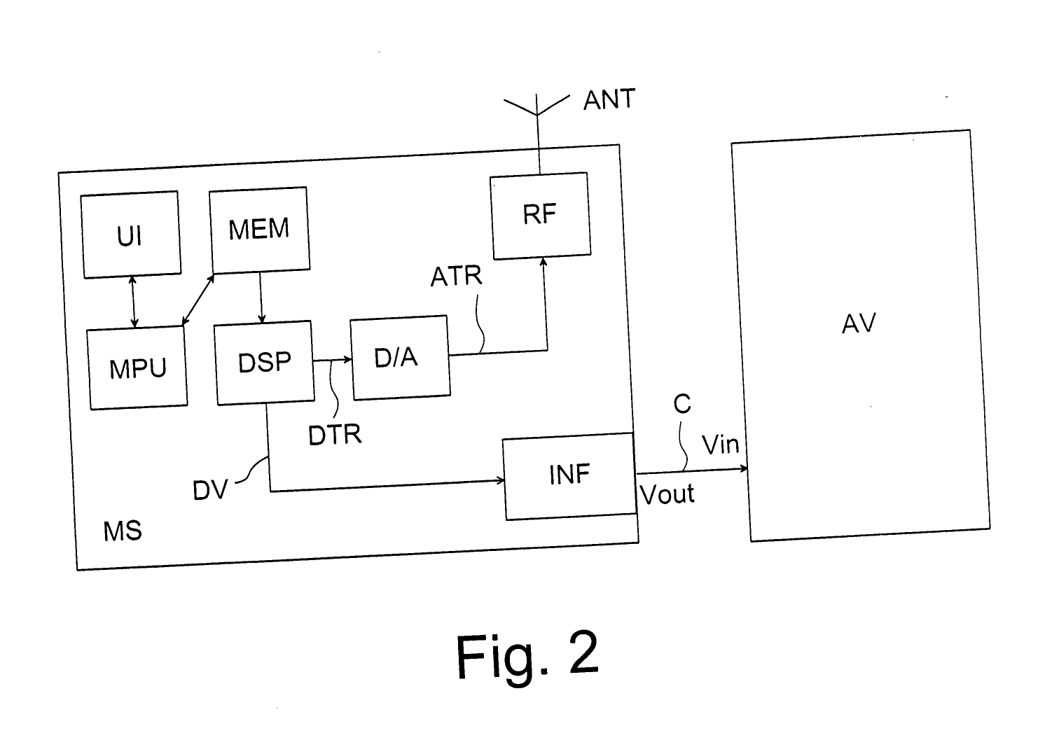

FIG. 2 shows, in a principle view as in FIG. 1, a mobile station MS according to another embodiment of the invention, in which the digital signal processor DSP is, controlled by the processor MPU, arranged to produce a digital video signal DV from the image material into the memory MEM, the digital video signal DV being coupled via an adapter INF to the digital video output Vout of the mobile station MS. The digital video output Vout may comprise one serial digital signal line or several signal lines in parallel. The standard IEEE 1394 specifies a digital video signal which is suitable for use in the invention, but the invention can also be used to produce other video signals which are suitable, for example, for a digital television environment. Digital video signal connections which are now already used in various AV devices include, for example, the FireWire™ and i.Link™ connections, which are both based on said IEEE 1394 standard.

The function to implement the analog or digital video output Vout of the mobile station according to the invention can be easily implemented in any such digital mobile stations which already comprise one or more sufficiently efficient and fast digital signal processors DSP for a wireless data transmission connection, and in the case of the analog video signal, also means for converting the digital signal further to a suitable analog format.

A significant advantage of the invention is that the implementation mostly requires only reprogramming of the functions of the mobile station MS. Additions required on the hardware level primarily include only the switch means S (in the case of the analog video signal) as well as the adapter INF needed in the interface. It will be obvious for anyone skilled in the art how said switch means S and adapter INF can be implemented even in a number of ways known as such from prior art, for both the analog ACV and the digital DV video signal.

In portable mobile stations MS, the size and weight of the device are quite significant factors in view of the convenience of its use; therefore, this also means in practice that it is not advantageous to equip the mobile station MS itself with a large connector of the type commonly used in video technology, for example an RCA female connector to be used in the case of analog video signals. Instead, the mobile station can be provided, in connection with the adapter INF, with a suitable small-sized connector to which it is possible to connect a small-sized adapter, if possible, which converts the connector further to e.g. the RCA female connector. To this adapter, it is further possible to couple a conventional RCA video cable. One alternative is to use a video cable specially made for the purpose, having, at its one end, a small-sized connector suitable for the video output Vout of the mobile station MS, and at its other end, correspondingly, a larger-sized connector suitable for the video input Vin of the AV device, for example an RCA male connector.

Particularly in the case of digital video signals, the adapter INF and one or more connectors used in it for the video output Vout can also be replaced with a wireless link, such as, for example, a short-range Bluetooth radio link.

In one possible embodiment of the mobile station MS according to the invention, the mobile station MS to be sold to the consumer is, on the hardware level, readily equipped with the function according to the invention, but the software of the mobile station MS does not, in its basic assembly, support said function. The consumer can, if he/she so wishes, load the software required by the function or activate the function by means of the manufacturer of the mobile station, the operator, or another service provider, by methods known as such from prior art. The user may subscribe to and/or download the function according to the invention to his/her mobile station for a charge, for example by using an SMS or WAP connection (WAP, Wireless Application Protocol).

The invention has only been described above by means of examples and primarily by describing embodiments producing an analog composite video signal and a digital video signal according to the IEEE 1394 standard. Now, one should note that FIGS. 1 and 2 only show, in principle views, those functional blocks of the mobile station MS which are essential for understanding the principle of the present invention. It will be obvious for anyone skilled in the art that for example the digital signal processor DSP, the converter D/A, the memory MEM, and the processor MPU can, in practice, be integrated in for example a single application specific integrated circuit (ASIC). Thus, the functions according to the invention may be implemented for example by means of a micro controller unit (MCU). Furthermore, FIG. 1 or 2 do not show in more detail the data transmission buses between the different blocks, or their principle of operation. For their implementation, there is a variety of methods known as such from prior art.

The mobile station MS may be for example a mobile phone, a multimedia phone, a camera phone, or a so-called PDA device (Personal Data Assistant), which comprises, for mobile station functions, one or more digital signal processors DSP suitable for the use according to the invention, as well as in the case of an analog video signal, suitable means for converting the digital signal generated by the digital signal processor further to an analog signal. One concrete example of a mobile station MS which comprises both mobile station functions and other data processing functions important for the different applications of the invention, is Nokia Communicator™.

The mobile station MS may be intended to operate, for example, in the GSM, GPRS (General Packet Radio Service); PDC (Personal Digital Cellular), CDMA IS-95 (Code Division Multiple Access), TDMA IS-136 (Time Division Multiple Access) networks, or in so-called third generation networks, such as WCDMA and CDMA-2000. In wireless systems of the third generation, which are generally called the Universal Mobile Telecommunication System (UMTS), the data transmission rates and the properties of the mobile stations are significantly more sophisticated than in systems of the second generation, thereby making it possible to implement the method according to the invention in an easier way. The mobile station MS may also comprise functions complying with the digital television system.

In a summary, the present invention makes it possible to connect the mobile station MS in quite a new way to various AV devices having an analog or digital video signal input Vin. These AV devices may be either display devices, video signal recording devices, or also devices which process a video signal in any other way. When using an analog composite video signal, a substantial advantage is that only one signal conductor can be used to transmit all the essential data needed to show a black-and-white or colored, moving or still image. The range of AV devices which accept the analog composite video signal is also very wide, ranging from television sets to various computer based devices. A particular advantage to be achieved in the use of the digital video signal is better image quality than in the use of the analog video signal. For this reason, it will be obvious that the significance and use of digital video signals in relation to analog video signals will be increased in the future.

The invention is by no means restricted to the properties of the image material to be presented by the method. By means of the method, depending on the resources of the mobile station MS, an analog or digital video signal can be formed of a moving or still image as well as from a black-and-white or color image. The image material may be generated in the mobile station MS itself, or it may be transferred to the memory of the mobile station MS in any way suitable for the purpose. It is also possible that a wireless or wired connection is used to connect another device to the mobile station MS which converts the image transmitted by the device to a video signal. However, this requires that the transmission of the image material from said second device will not bind the resources of the digital signal processor DSP or other functional blocks of the mobile station MS in such a way that the conversion of the video signal according to the invention becomes impossible.

It will be obvious for anyone skilled in the art that by combining, in different ways, the methods, modes of operation and device structures presented above in connection with embodiments of the invention, it is possible to provide various embodiments of the invention in accordance with the spirit of the invention. Therefore, the above-presented examples must not be interpreted as restrictive to the invention, but the embodiments of the invention can be freely varied within the scope of the inventive features presented in the claims hereinbelow.

1. A method for use in a digital mobile station (MS) operating in a wireless communication network, which mobile station (MS) comprises at least one or more digital signal processors (DSP) or corresponding processing means to generate a digital transmission signal flow (DTR) for a wireless transmission connection to be used in said communication network, comprising the steps of:
generating a video signal in said mobile station (MS) by
controlling said at least one or more digital signal processors (DSP) or corresponding processing means to generate, instead of the transmission signal flow (DTR), one or more digital video signal flows (DCV, DV) from image material stored in or transmitted into the memory (MEM) of the mobile station (MS).

2. The method according to claim 1, wherein said at least one or more digital video signal flows (DCV, DV) are formed from the image material contained in the mobile station (MS) one image at a time in such a way that in a single image, the conversion to the video signal is performed image line by image line.

3. The method according to claim 1, wherein said one or more digital video signal flows (DV) are led to a digital video output (Vout) of the mobile station (MS).

4. The method according to claim 3, wherein said digital video output (Vout) is arranged according to the IEEE 1394 standard.

5. The method according to claim 3, wherein said digital video output (Vout) is arranged to be suitable for a digital television environment.

6. The method according to claim 1, wherein said one or more digital video signal flows (DCV) are converted in the mobile station (MS) to one or more analog video signals (ACV) which is/are further led to an analog video output (Vout) of the mobile station (MS).

7. The method according to claim 6, wherein said one or more digital video signal flows (DCV) are converted in the mobile station (MS) to one or more analog video signals (ACV) by using substantially the same conversion means (D/A) which are used in the mobile station (MS) to convert an analog transmission signal (ATR) from a digital transmission signal flow (DTR) for a wireless connection in a communication network.

8. The method according to claim 7, wherein said one or more analog video signals (ACV) are led to the video output (Vout) of the mobile station, by simultaneously disconnecting said conversion means (D/A) off from the radio frequency part (RF) or corresponding transmission means of the mobile station (MS).

9. The method according to claim 6, wherein said analog video output (Vout) is arranged on the basis of a composite video signal.

10. The method according to claim 9, wherein said analog video output (Vout) is arranged according to one of the following systems: PAL, NTSC or SECAM system.

11. The method according to claim 3, wherein before leading said one or more digital video signal flow (DV) to the video output (Vout), said one or more signal (DV) is amplified in an adapter (INF) or corresponding means.

12. The method according to claim 6, wherein before leading said one or more analog video signal (ACV) to the video output (Vout), said one or more signal (ACV) is amplified in an adapter (INF) or corresponding means.

13. The method according to claim 6, wherein the coupling impedance of said analog video output (Vout) is matched in an adapter (INF) or corresponding means.

14. A digital mobile station (MS) operating in a wireless communication network, which mobile station (MS) comprises:
a memory (MEM); and
at least one or more digital signal processors (DSP) or corresponding processing means to generate a digital transmission signal flow (DTR) for a wireless transmission connection to be used in said communication network, wherein for generating a video signal in said mobile station (MS), said at least one or more digital signal processors (DSP) or corresponding processing means are controlled to generate, instead of the transmission signal flow (DTR), one or more digital video signal flows (DCV, DV) from image material stored in or transmitted into the memory (MEM) of the mobile station (MS).

15. The mobile station (MS) according to claim 14, wherein said one or more digital signal processors (DSP) or corresponding processing means are arranged to generate said one or more digital video signal flows (DCV, DV) from image material contained in the mobile station (MS) one image at a time in such a way that in a single image, the conversion to the video signal is made image line by image line.

16. The mobile station (MS) according to claim 14, wherein said one or more digital video signal flows (DV) are arranged to be led to the digital video output (Vout) of the mobile station (MS).

17. The mobile station (MS) according to claim 16, wherein said digital video output (Vout) is arranged to be formed according to the IEEE 1394 standard.

18. The mobile station according to claim 16, wherein said digital video output (Vout) is arranged to be suitable for a digital television environment.

19. The mobile station (MS) according to claim 14, wherein the mobile station (MS) comprises means for converting said one or more digital video signal flows (DCV) to one or more analog video signals (ACV) and for conducting said signal/signals further to an analog video output (Vout) of the mobile station (MS).

20. The mobile station (MS) according to claim 19, wherein said one or more digital video signal flows (DCV) are converted in the mobile station (MS) to one or more analog video signals (ACV) by using substantially the same conversion means (D/A) which are used in the mobile station (MS) to convert a digital transmission signal flow (DTR) into an analog transmission signal (ATR) for a wireless connection in a communication network.

21. The mobile station (MS) according to claim 20, wherein the mobile station (MS) also comprises a switching means (S) for leading said one or more analog video signals (ACV) to the video output (Vout) of the mobile station, the switching means (S) being thus also arranged to disconnect said conversion means (D/A) off from the radio frequency part (RF) or corresponding transmission means of the mobile station (MS).

22. The mobile station (MS) according to claim 19, wherein said analog video output (Vout) is arranged to be formed on the basis of a composite video signal.

23. The mobile station (MS) according to claim 22, wherein said analog video output (Vout) is arranged to be formed according to on of the following systems: PAL, NTSC or SECAM system.

24. The mobile station (MS) according to claim 16, wherein the mobile station (MS) also comprises an adapter (INF) or corresponding means for amplifying said one or more digital video signal flows (DV) before said one or more signals are led to the digital video output (Vout) of the mobile station.

25. The mobile station (MS) according to claim 19, wherein the mobile station (MS) also comprises an adapter (INF) or corresponding means for amplifying said one or more analog video signals (ACV) before said one or more signals are led to the analog video output (Vout) of the mobile station.

26. The mobile station (MS) according to claim 25, wherein said adapter (INF) or corresponding means are arranged to match the coupling impedance of said analog video output (Vout).

27. The mobile station (MS) according to claim 14, wherein the mobile station (MS) is arranged to operate in one or more of the following wireless networks: GSM, GPRS, PDC, CDMA IS-95, TDMA IS-136, WCDMA, or CDMA-2000.

28. Application software embodied in a computer radable medium for a digital mobile station (MS), which mobile station (MS) comprises at least one or more digital signal processors (DSP) or corresponding processing means to generate a digital transmission signal flow (DTR) for a wireless transmission connection to be used in the communication network, wherein said application software when loaded in the mobile station (MS) and executed in the mobile station (MS) is arranged to control said at least one or more digital signal processors (DSP) or corresponding processing means to generate, instead of the transmission signal flow (DTR), one or more digital video signal flows (DCV, DV) from image material stored in or transmitted into the memory (MEM) of the mobile station (MS).

29. The application software according to claim 28, wherein the application software is arranged to lead said one or more digital video signal flows (DV) to the digital video output (Vout) of the mobile station (MS).

30. The application software according to claim 29, wherein the application software is arranged to control the conversion of said one or more digital video signal flows (DCV) to one or more analog video signals (ACV) in the mobile station (MS), and to conduct said signal/signals further to the analog video output (Vout) of the mobile station (MS).

31. A system for displaying visual information, the system comprising a digital mobile station (MS) and at least one external audiovisual device (AV) coupled to said mobile station (MS) in order to display image material stored in or transmitted into the memory (MEM) of the mobile station (MS), wherein the one or more digital signal processors (DSP) or corresponding processing means comprised in the mobile station (MS) and which are during a wireless transmission connection arranged to generate a digital transmission signal flow (DTR), are instead of said digital transmission signal flow (DTR) controlled to generate one or more digital video signal flows (DCV, DV) from the image material stored in or transmitted into the memory (MEM) of the mobile station (MS), and that the mobile station (MS) further comprises means for conducting said one or more digital video signal flows (DCV,DV) to said at least one external audiovisual device (AV) via an digital or analog video signal (DV,ACV) output (Vout).

32. The system according to claim 31, wherein said audiovisual device (AV) is a television set, a monitor, a data or video projector, a video recorder, a DVD device, a computer, or another display device or video signal recording device equipped with an analog or digital video input (Vin).
